(19) United States
(12) Patent Application Publication
(10) Pub. No.: US 2003/0114055 A1
(43) Pub. Date: Jun. 19, 2003

(54) Composite vapor barriers for use as safety nets in buildings

(75) Inventors: Jana E. Burton, Honea Path, SC (US); J. Todd Horne, Rock Hill, SC (US)

Correspondence Address: DORITY & MANNING, P.A., POST OFFICE BOX 1449, GREENVILLE, SC, 29602-1449, US

(73) Assignee: VyTech Industries, Incorporated

(21) Appl. No.: 10/023,487

(22) Filed: Dec. 18, 2001

(51) Int. Cl. B32B 15/14; E04B 5/00; D03D 15/00; D04B 21/00; D03D 9/00; D04C 1/00; D04B 1/00; D04G 1/00; D03D 19/00; B32B 27/12; B32B 27/04

(52) U.S. Cl. 442/31; 442/38; 442/49; 52/408

(57) ABSTRACT

A composite vapor barrier for use between one or more spaces defined by the structural elements (e.g., purlins) of a building is provided. In one embodiment, the composite vapor barrier is formed from a scrim thermally bonded to metallized film and vinyl facing layers. In one embodiment, the scrim can be a triaxial scrim. The composite vapor barrier of the present invention is sufficiently strong such that it does not substantially rupture when a bag of sand having a weight of approximately 400 pounds and a diameter of approximately 30 inches is dropped thereon from a distance of about 42 inches above an upper surface of the barrier.

### BACKGROUND OF THE INVENTION

During construction of a building, various purlins and other structural members are installed as the framework for the roof. Large spaces are formed between the purlins and/or structural members that can pose a risk to workers who might fall through the spaces while on the roof. As a result of the potential danger to workers, various safety nets have been developed to extend underneath, over and between the purlins and/or structural members. These safety nets are designed to have sufficient strength to catch a worker from falling through the spaces to the ground. However, despite the benefits achieved by such conventional safety nets, water vapor often permeates through the nets.

As a result, various materials have been developed to include a vapor barrier. For example, one such barrier is described in U.S. Pat. No. 6,094,883 to Atkins. The barrier of Atkins is formed from outer layers of vinyl and metallized polyester bonded to an inner fiberglass scrim or mesh. The outer layers are said to provide a vapor barrier in order to protect the insulation from moisture accumulation. However, although possessing a vapor barrier attribute, such materials are typically found to have inadequate strength. For example, when subjected to a certain force, such barriers tend to rupture.

Thus, a need currently exists for an improved vapor barrier that possesses enough strength for use in safety net applications.

### SUMMARY OF THE INVENTION

In accordance with one embodiment of the present invention, a composite vapor barrier is provided for use between one or more spaces defined by the structural elements (e.g., purlins) of a building. The composite vapor barrier comprises a first facing layer formed from a material that is generally impermeable to water vapor and a scrim bonded (e.g., thermally bonded) to the first facing layer.

In some embodiments, the first facing layer is formed from a material selected from the group consisting of vinyl, a metallized film (e.g., metallized polyester), foil, a polyolefin, kraft, and combinations thereof. In one particular embodiment, the first facing layer is a metallized film. In addition, the composite vapor barrier can also comprise a second facing layer formed from a material that is general impermeable to water vapor. The second facing layer may, in some embodiments, be formed from the group consisting of vinyl, a metallized film, foil, a polyolefin, kraft, and combinations thereof. In one particular embodiment, the second facing layer is formed from vinyl. If desired, one or more surfaces of either of the facing layers can be applied with an adhesive coating.

As stated above, the composite vapor barrier also includes a scrim. For instance, in one embodiment, the scrim is a triaxial scrim. In some embodiments, the scrim can have a weight of at least about 2.0 oz/yd², in some embodiments between about 2.0 to about 8.0 oz/yd², and in some embodiments, between about 3.0 to about 6.5 oz/yd².

As a result of the present invention, it has been discovered that a composite vapor barrier can be formed that is generally impermeable to water vapor and strong. Specifically, the composite vapor barrier of the present invention does not substantially rupture when a bag of sand having a weight of approximately 400 pounds and a diameter of 30±2 inches is dropped onto the barrier from a distance of about 42 inches above an upper surface of the barrier.

Other features and aspects of the present invention are discussed in more detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a schematic illustration of one embodiment of a composite vapor barrier of the present invention.

FIG. 2 is a schematic illustration of a triaxial scrim that can be used in one embodiment of the composite vapor barrier of the present invention; and

FIG. 3 is a schematic illustration of one embodiment of a method for forming a composite vapor barrier of the present invention.

### DETAILED DESCRIPTION OF REPRESENTATIVE EMBODIMENTS

It is to be understood by one of ordinary skill in the art that the present discussion is a description of exemplary embodiments only, and is not intended as limiting the broader aspects of the present invention, which broader aspects are embodied in the exemplary construction.

In general, the present invention is directed to a composite vapor barrier that is strong and generally impermeable to water vapor for use between one or more spaces defined by the structural elements (e.g., purlins) of a building. For example, it has been discovered that a composite vapor barrier formed according to the present invention can fulfill or exceed the strength requirements of current Occupational Safety and Health Administration (OSHA) standard 1926.502 (c)(4)(i). OSHA standard 1926.502 (c)(4)(i) requires that a safety barrier or net be capable of withstanding a 400 pound (180 kg) bag of sand (30±2 inches in diameter) dropped into the net from the highest walking/working surface at which employees are exposed to fall hazards, but not less than 42 inches above the safety net. Moreover, because vapor barriers of the present invention may be thermally bonded together under pressure, the strength of the overall composite structure is enhanced.

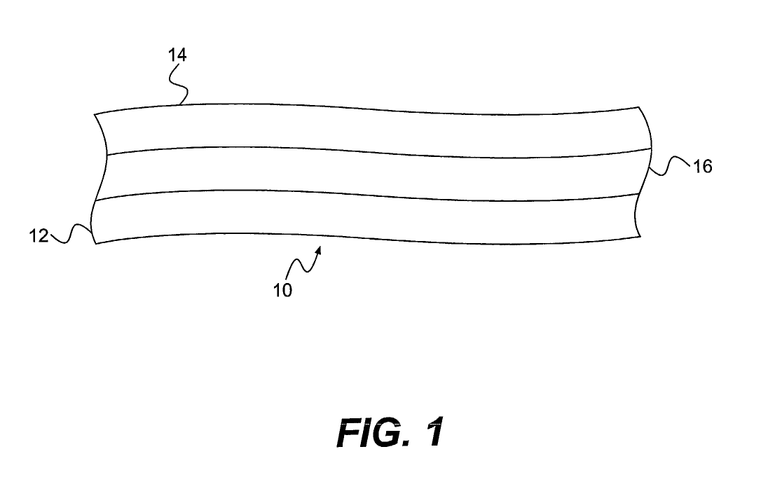

Referring to FIG. 1, one embodiment of a composite vapor barrier 10 is illustrated. In this embodiment, the composite vapor barrier 10 includes three layers 12, 14, and 16 that are laminated together. It should be understood, however, that the composite vapor barrier of the present invention need not include three layers, but can include any number of desired layers so long as the resulting composite vapor barrier is relatively strong and has the desired vapor barrier properties.

For instance, in one embodiment, the layer 16 is a scrim. As used herein, a “scrim” generally refers to woven, nonwoven, or other types of fabrics. The characteristics of the scrim can generally be selected to optimize strength. For example, the size of the threads, the type of weave, the spacing of the threads, the weight of the scrim, and the material used to form the scrim 16 can all be varied to obtain a scrim having enhanced strength. In this regard, various characteristics of one embodiment of a scrim used in the present invention will now be described in more detail. It should be understood, however, that the embodiment described below represents only one combination of traits that can achieve the desired strength. For instance, one of the traits discussed below may be altered in a manner that significantly decreases strength, so long as another trait is altered in a manner to counteract this loss in strength.

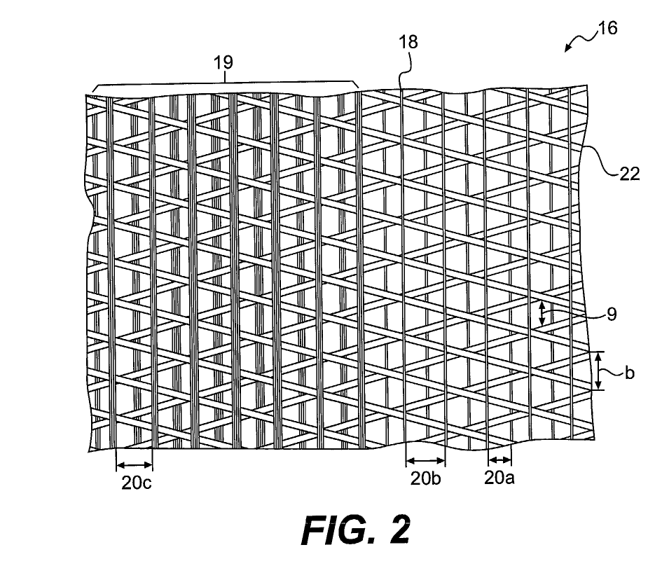

Thus, referring to FIG. 2, one particular embodiment of a scrim 16 is illustrated. Specifically, the scrim 16 is formed from machine-direction threads 18 and cross-direction threads 22 wound around a selvage thread (not shown) to form a triaxial scrim. Although not required, such multi-directional threads can increase the overall strength of the scrim 16. Moreover, other types of weaves or patterns can also be used to form scrims of the present invention, including, but not limited to, basket, twill, satin, plain, and Leno weaves. Other suitable scrim constructions may be described in U.S. Pat. No. 5,108,831 to Green, U.S. Pat. No. 5,525,413 to Daurer, et al., and U.S. Pat. No. 5,540,971 to Daurer, et al., which are incorporated herein in their entirety by reference thereto for all purposes.

The spacing of the threads can also be varied to enhance the strength of the scrim 16. For example, in one embodiment, as shown in FIG. 2, the machine-direction threads 18 are spaced in an alternating pattern across the width of the scrim 16. Specifically, in the illustrated embodiment, the machine-direction threads 18 are spaced apart to form a space 20b and a second space 20a that is smaller in width than the space 20b. For example, in one embodiment, the space 20a has a width of approximately 1/16 inches and the space 20b has a width of approximately 3/16 inches. Further, in the illustrated embodiment, the cross-direction threads 22 are spaced apart such that the distance “a” is approximately ¼ inches and the distance “b” is also approximately ¼ inches.

Besides the above-mentioned traits, the size of the threads 18 and 22 can also be selected to enhance the strength of the scrim 16. For example, in one embodiment, the machine-direction threads 18 have a width of about 1/16 inches and the cross-direction threads 22 have a width of about 1/16 inches. In this embodiment, the selvage threads (not shown) can have a width of about 1/32 inches. Moreover, if desired, one or both of the selvage areas 19 located on the sides of the scrim 16 (one of which is shown in FIG. 2) can contain additional machine-direction threads 18 to increase the strength of the scrim 16. For instance, in the selvage area 19, the use of additional machine-direction threads 18 can result in an effective thickness of the threads 18 of about ⅛ inches. Further, in the selvage area 19, the machine-direction threads 18 may be positioned apart to form a space 20c. In one embodiment, for example, the space 20c can be about 3/16 inches.

The threads 18 and 22 can generally be formed from any of a variety of materials, including, but not limited to, polyester, polypropylene, polyethylene, nylon, fiberglass, Kevlar®, blends thereof, and the like. For example, in one embodiment, both the threads 18 and 22 are formed from polyester fibers. Although not required, it is typically desired that the threads 18 and 22 be generally fire retardant to enhance the overall fire retardancy of the vapor barrier 10. In this regard, in one embodiment of the present invention, the scrim 16 is applied with a generally fire retardant coating, such as a plastisol polyvinylchloride-based coating. Moreover, other materials, such as dyes, smoke inhibitors, and the like, may be also applied to the scrim 16 if desired.

The scrim 16 can be made with various basis weights in order to optimize its properties for a particular application. For instance, the scrim 16 can be coated, such as referenced above, and formed so that the resulting basis weight is at least about 2.0 oz/yd², in some embodiments between about 2.0 to about 8.0 oz/yd², and in some embodiments, between about 3.0 to about 6.5 oz/yd². In one embodiment, for example, the coated scrim has a basis weight of about 6.0 oz/yd². Moreover, the scrim 16 may also have a variety of different thicknesses. For example, in some embodiments, the scrim 16 has an average thickness less than about 0.0025 inches. In one particular embodiment, the scrim 16 has a selvage thickness of 0.0018 inches and a middle thickness of 0.0022 inches.

Referring again to FIG. 1, the vapor barrier 10 also includes two barrier layers 12 and 14 that are generally impermeable to water vapor. By being impermeable to water vapor, the layers 12 and 14 can protect the insulation from moisture accumulation. In general, the barrier layers 12 and 14 can be formed from any vapor-impermeable material desired. For instance, some examples of suitable materials for the barrier layers 12 and 14 include, but are not limited to, vinyl, metallized films (e.g., metallized polyester, metallized polypropylene, metallized polyethylene, etc.), foil, polyolefins (polypropylene, polyethylene, etc.), kraft (e.g., natural, white, etc.), all combinations thereof, and the like. In one particular embodiment, the barrier layer 12 is formed from a metallized film, such as metallized polyester.

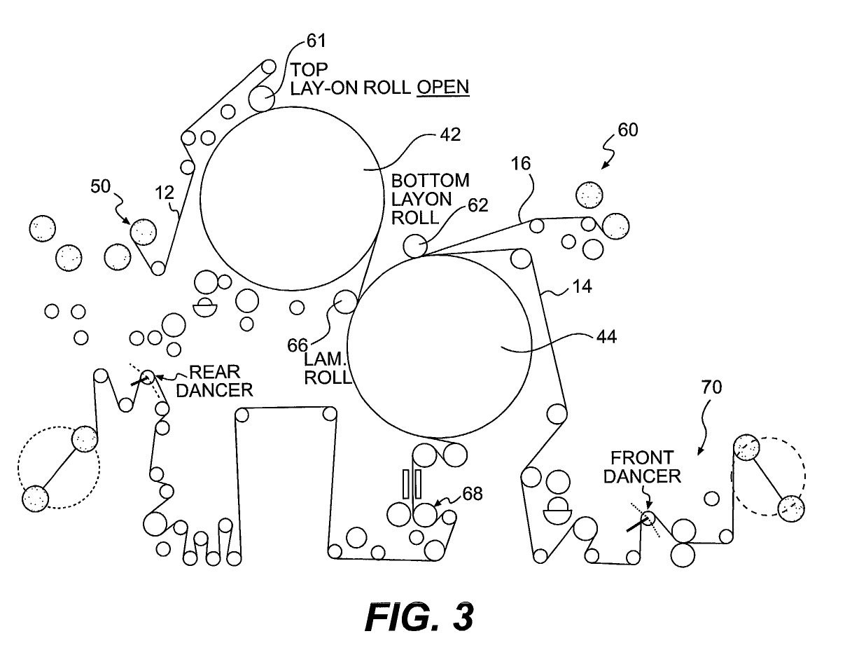

Once the desired layers are provided, the vapor barrier 10 can be formed according to any of a variety of different techniques. For example, referring to FIG. 3, one particular embodiment for forming the vapor barrier 10 is illustrated. For simplicity, various tensioning rolls schematically used to define the several runs are shown but not numbered. As shown, a metallized polyester barrier layer 12 is initially coated with an adhesive and supplied to the process at a location 50. In this embodiment, the coating facilitates the bonding of the barrier layers 12 and/or 14 to the scrim 16, and also enhances the strength of the scrim 16 by further bonding together the threads at their crossover points. Any well-known material that is capable of bonding the scrim 16 the barrier layer 12 and/or 14 can be utilized. For example, in one embodiment, as indicated above, a polyvinychloride-based adhesive coating can be utilized. From the location 50, the adhesive-coated metallized polyester layer 12 is wound onto the upper drum 42 that is heated to a certain temperature, which is typically between about 25° F. to about 350° F. At the upper drum 42, a top lay-on roll 61 compresses the layer 12 against the upper drum 42.

The scrim 16 and a vinyl barrier layer 14 are also supplied to the process via locations 60 and 70, respectively. Specifically, the vinyl layer 14 is wound from the location 70 to a lower drum 44 that is heated to a certain temperature, which is typically between about 25° F. to about 350° F. The scrim is also wound from the location 60 to the heated lower drum 44. At the lower drum 44, a bottom lay-on roll 62 compresses the layers 14 and 16 against the lower drum 44. It should be understood that some or all of the layers may also be applied in liquid form through various coating methods.

From the drum 42, the metallized polyester layer 12 is then further wound so that its adhesive-coated surface is placed into contact with the layers 14 and 16. A laminating roll 66 presses all of the layers against the heated lower drum 44, thereby fusing and thermally bonding such layers together to form the composite vapor barrier 10. The vapor barrier 10 is then heated and transported to a textured embossing roll 68, where texture is imparted to a surface of the composite vapor barrier 10, and then immediately cooled.

Besides or in conjunction with the above-mentioned techniques, other coating and/or bonding processes may also be utilized to form the vapor barrier 10. For example, some suitable coating and/or bonding processes that can be used include, but are not limited to, gravure coating, 3-roll offset gravure coating, metering rod coating, squeeze (pad) coating, 3-roll reverse roll coating, fountain fed contracoating, direct die coating, knife over roll coating, 3-roll nip fed reverse roll coating, transfer roll (5-roll) coating, air doctor coating, flat cast film lining, extrusion coating, co-extrusion, screen coating, die coating, reverse roll coating, and the like.

Once formed, the vapor barrier 10 can have a variety of different properties. For example, the vapor barrier 10 typically has a weight of less than about 10.5 oz/yd², in some embodiments between about 3 to about 10 oz/yd², and in some embodiments, between about 6 to about 9 oz/yd². Additionally, vapor barriers formed according to the present invention generally have an average thickness less than about 0.03 inches. For example, in one embodiment of the present invention, the vapor barrier 10 weighs 8.5 oz/yd² and has a selvage thickness of 0.027 inches and a middle thickness of 0.023 inches.

In addition, the vapor barrier 10 may also be installed into a building in any manner desired. For example, various methods for installing barriers into a building are described in U.S. Pat. No. 6,094,883 to Atkins, U.S. Pat. No. 5,953,875 to Harkins, U.S. Pat. No. 4,573,298 to Harkins, and U.S. Pat. No. 4,446,664 to Harkins, which are incorporated herein in their entirety by reference thereto for all purposes. When positioning the vapor barrier 10 in a building structure, it may be desired to face the barrier layer 12 toward the interior of the building to reflect heat into the building for improving insulation. It should also be understood, however, that the barrier layer 12 can also face the exterior of the building if desired.

The present invention may be better understood with reference to the following example.

### EXAMPLE

The ability of a vapor barrier formed according to the present invention to satisfy industry strength requirements was demonstrated.

A vapor barrier was initially formed from a nonwoven scrim layer sandwiched between two barrier layers. One of the barrier layers was a metallized polyester film and the other barrier layer was a vinyl material. The scrim was a triaxial polyester nonwoven scrim, such as shown in FIG. 2 and described above, and was obtained from Milliken. The scrim had a selvage gauge of 0.018 inches and a middle gauge of 0.022 inches. The machine direction and cross direction threads had a width of 1/16 inches. The scrim was coated with a polyvinylchloride-based material so that the combined weight of the scrim and the coating was 6.0 ounces per square yard.

The vapor barrier was formed according to the process illustrated in FIG. 3, using the following processing conditions:

| | |
|---|---|
| Upper drum temperature: | 225° F. |
| Lower drum temperature: | 271° F. |
| Embossing pressure: | 40 psi |
| Embossing temperature: | No heat lamps, |
| | Average temp = |
| | 212° F. |
| Bottom lay down roll pressure: | 20 psi |
| Vinyl unwind tension: | 12-25 psi |
| Scrim unwind tension: | 20 psi |
| Metallized polyester unwind tension: | 20 psi |
| Top lay down roll pressure: | 55 psi |
| Laminating roll pressure: | 100 psi |
| Wind-up Speed | 15.8 yd/min |

Once formed, the resulting vapor barrier had a weight of 8.5 ounces per square yard.

This vapor barrier was then in installed in a building according to the method described in U.S. Pat. No. 6,094,883 to Atkins. Once installed, the vapor barrier was tested according to Occupational Safety and Health Administration (OSHA) standard 1926.502 (c)(4)(i). Specifically, a bag of sand having a weight of approximately 400 pounds and a diameter of approximately 30±2 inches was dropped onto the safety barrier from 42 inches above the barrier. The bag of sand did not rupture the safety barrier.

These and other modifications and variations to the present invention may be produced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A composite vapor barrier for use between one or more spaces defined by the structural elements of a building, said composite vapor barrier comprising:
a first facing layer formed from a material that is generally impermeable to water vapor, wherein at least one surface of said first facing layer is applied with an adhesive coating; and
a scrim bonded to said first facing layer;
wherein the composite vapor barrier does not substantially rupture when a bag of sand having a weight of approximately 400 pounds and a diameter of approximately 30 inches is dropped onto said composite vapor barrier from a distance of about 42 inches above an upper surface of said composite vapor barrier.

2. A composite vapor barrier as defined in claim 1, wherein said first facing layer is formed from a material selected from the group consisting of vinyl, a metallized film, foil, a polyolefin, kraft, and combinations thereof.

3. A composite vapor barrier as defined in claim 1, wherein said first facing layer is formed from a metallized film.

4. A composite vapor barrier as defined in claim 1, further comprising a second layer formed from a material that is generally impermeable to water vapor.

5. A composite vapor barrier as defined in claim 4, wherein said first and said second facing layers are formed from a material selected from the group consisting of vinyl, a metallized film, foil, a polyolefin, kraft, and combinations thereof.

6. A composite vapor barrier as defined in claim 4, wherein said second facing layer is formed from vinyl.

7. A composite vapor barrier as defined in claim 4, wherein said first facing layer is formed from a metallized film and said second layer is formed from vinyl.

8. A composite vapor barrier as defined in claim 1, wherein said scrim is a triaxial scrim.

9. A composite vapor barrier as defined in claim 1, wherein said scrim includes threads formed from polyester fibers.

10. A composite vapor barrier as defined in claim 1, wherein said scrim has a weight at least about 2 ounces per square yard.

11. A composite vapor barrier as defined in claim 1, wherein said scrim has a weight of between about 2 ounces per square yard to about 8 ounces per square yard.

12. A composite vapor barrier as defined in claim 1, wherein said scrim has a weight of between about 3.0 ounces per square yard to about 6.5 ounces per square yard.

13. A composite vapor barrier as defined in claim 1, wherein said vapor barrier has a weight of between about 3 ounces per square yard to about 10 ounces per square yard.

14. A composite vapor barrier as defined in claim 1, wherein said vapor barrier has a weight of between about 6 ounces per square yard to about 9 ounces per square yard.

15. A composite vapor barrier as defined in claim 1, wherein said vapor barrier has an average thickness of less than about 0.03 inches.

16. A composite vapor barrier as defined in claim 1, wherein said scrim includes a selvage area that contains an additional number of machine-direction threads.

17. A composite vapor barrier as defined in claim 1, wherein said scrim is thermally bonded to said first facing layer.

18. A composite vapor barrier for use between one or more spaces defined by the structural elements of a building, said composite vapor barrier comprising:
a first facing layer comprising a metallized film that is generally impermeable to water vapor;
a second facing layer comprising a vinyl material that is generally impermeable to water vapor, wherein at least one surface of at least one of said facing layers is applied with an adhesive coating; and
a triaxial scrim thermally bonded to and positioned between said first and said second facing layers;
wherein the composite vapor barrier does not substantially rupture when a bag of sand having a weight of approximately 400 pounds and a diameter of approximately 30 inches is dropped onto said composite vapor barrier from a distance of about 42 inches above an upper surface of said composite vapor barrier.

19. A composite vapor barrier as defined in claim 18, wherein said scrim includes machine-direction and cross-direction threads.

20. A composite barrier as defined in claim 19, wherein machine-direction and said cross-direction threads are formed from polyester fibers.

21. A composite vapor barrier as defined in claim 19, wherein said scrim includes a selvage area that contains an additional number of machine-direction threads.

22. A composite vapor barrier as defined in claim 18, wherein said scrim has a weight of between about 3.0 ounces per square yard to about 6.5 ounces per square yard.

23. A composite vapor barrier as defined in claim 18, wherein said vapor barrier has a weight of between about 6 ounces per square yard to about 9 ounces per square yard.

24. A method of forming a composite vapor barrier for use between one or more spaces defined by the structural elements of a building, said method comprising:
providing first and second facing layers that are generally impermeable to water vapor;
positioning a scrim adjacent to and between said first facing layer and said second facing layer; and
simultaneously applying heat and pressure to said each of said layers to form a composite vapor barrier with sufficient strength such that the composite vapor barrier does not substantially rupture when a bag of sand having a weight of approximately 400 pounds and a diameter of approximately 30 inches is dropped onto said composite vapor barrier from a distance of about 42 inches above an upper surface of said composite vapor barrier.

25. A method as defined in claim 24, further comprising applying an adhesive coating to at least one surface of at least one of said facing layers.

26. A method as defined in claim 24, wherein said layers are thermally bonded at a temperature between about 25° F. to about 350° F.

27. A method as defined in claim 24, wherein said first facing layer comprises a metallized film.

28. A method as defined in claim 24, wherein said second facing layer comprises a vinyl material.

29. A method as defined in claim 24, wherein said first facing layer comprises a metallized film and said second facing layer comprises a vinyl material.

30. A method as defined in claim 24, wherein said scrim is a triaxial scrim.

31. A method as defined in claim 24, wherein said scrim includes threads formed from polyester fibers.

32. A method as defined in claim 24, further comprising embossing at least one surface of said composite vapor barrier to impart texture thereto.
